(19) United States
(12) Patent Application Publication
(10) Pub. No.: US 2008/0244466 A1
(43) Pub. Date: Oct. 2, 2008

(54) SYSTEM AND METHOD FOR INTERFACING WITH INFORMATION ON A DISPLAY SCREEN

(76) Inventor: Timothy James Orsley, San Jose, CA (US)

Correspondence Address: Kathy Manke;Avago Technologies Limited, 4380 Ziegler Road, Fort Collins, CO, 80525, US

(21) Appl. No.: 11/742,683

(22) Filed: May 1, 2007

Related U.S. Application Data
(63) Continuation-in-part of application No. 11/691,464, filed on Mar. 26, 2007.

(51) Int. Cl. G06F 3/033

(52) U.S. Cl. 715/863

(57) ABSTRACT

A technique for interfacing with graphical information on a display screen involves using a hand-held controller unit to collect image information that includes at least a portion of the display screen and using the image of the display screen to generate position data that is indicative of the position of the hand-held controller unit relative to the display screen. An action in a computer program related to the graphical information is then triggered in response to the position data and in response to a user input at the hand-held controller unit. Using this technique, a user can navigate a graphical user interface on a display screen with a hand-held controller unit without relying on beacon-based navigation.

### CROSS-REFERENCE TO RELATED APPLICATION

This application is a continuation-in-part of previously filed and co-pending patent application Ser. No. 11/691,464, filed 26 Mar. 2007.

### BACKGROUND OF THE INVENTION

In systems for optical navigation, frames of image data are sequentially captured and compared to track displacements of features in the frames relative to the optical navigation system. These relative displacements of the features in the frames can be used to estimate the motion of the features relative to the optical navigation system or the motion of the optical navigation system relative to the features. As an example, the relative displacements of the features can be used to track the movements of a computer mouse to control a cursor on a computer screen.

In some applications, the tracked features may be beacons (e.g., infrared sources) that are captured and used as reference points for optical navigation. The beacon sources are usually stationary, and thus, serve as reference points to determine relative motion of the optical navigation system. This type of optical navigation technique will be referred to herein as a beacon-based navigation technique. Beacon-based navigation techniques are currently used in computer gaming units to track motion of remote input devices for the gaming units.

A concern with conventional beacon-based navigation techniques is that additional hardware is needed to provide the beacons, which adds cost and undesired complexity to the overall system. Another concern is that non-beacon light sources in the field of view, e.g., candles and reflections of light, can be mistaken for the beacons, which can introduce navigation errors.

In some applications, the tracked features may be distinguishing features in a captured image frame. This type of optical navigation technique will be referred to herein as a scene-based navigation technique. Scene-based navigation techniques are similar to the navigation techniques employed in optical computer mice. Positional changes of the distinguishing features captured in successive frames of image data are used to track the motion of the optical navigation system. Scene-based navigation techniques can also be used in computer gaming units to track motion of remote input devices for the gaming units.

A concern with conventional scene-based navigation techniques is that significant navigation errors can sometimes be introduced during navigation. Such navigation errors may not be critical for applications that are not time-sensitive, such as cursor control for word processing applications. However, for time-sensitive applications, such as computer gaming, such navigation errors may not be tolerable.

Thus, there is a need for a system and method for reliably tracking an input device, such as a remote input device of a gaming unit, which does not require beacons sources.

In addition to reliably tracking the movement of an input device, it is typically desirable to enable a user to interface with graphical information that is displayed on a display device. For example, it is desirable to enable a user to interface with a video game through a hand-held controller unit. Some gaming units have utilized beacon-based navigation to enable a user to interface with a graphical user interface. However, systems that rely on beacon-based navigation are subject to the above-mentioned limitations.

### SUMMARY OF THE INVENTION

A technique for interfacing with graphical information on a display screen involves using a hand-held controller unit to collect image information that includes at least a portion of the display screen and using the image of the display screen to generate position data that is indicative of the position of the hand-held controller unit relative to the display screen. An action in a computer program related to the graphical information is then triggered in response to the position data and in response to a user input at the hand-held controller unit. Using this technique, a user can navigate a graphical user interface on a display screen with a hand-held controller unit without relying on beacon-based navigation.

The ability to interface with the graphical information on the display screen is enhanced if the user of the hand-held controller unit is provided with a visible indication of the position of the hand-held controller unit relative to the display screen, e.g., an indication of where the hand-held controller unit is pointed. In an embodiment, the hand-held controller unit generates a light beam that indicates the direction in which the controller unit is pointed. The light beam is visible as a spot on the display screen and provides instantaneous feedback to the user as to the position of the hand-held controller unit relative to the display screen. In another embodiment, a visible indication of the position of the hand-held controller unit relative to the display screen is electronically generated from the position data and displayed as a graphical element on the display screen.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows an optical navigation system in accordance with an embodiment of the invention.

FIG. 2A illustrates an imaged display screen in captured image frames when a hand-held controller unit of the optical navigation system is moved closer or farther from a display screen of the system in accordance with an embodiment of the invention.

FIG. 2B illustrates an imaged display screen in captured image frames when the hand-held controller unit is moved laterally at a fixed distance from the display screen in accordance with an embodiment of the invention.

FIG. 2C illustrates an imaged display screen in captured image frames when the hand-held controller unit is moved such that the angle of the hand-held controller unit with respect to the display screen is changed in accordance with an embodiment of the invention.

FIG. 3 is a block diagram of the hand-held controller unit of the optical navigation system of FIG. 1 in accordance with an embodiment of the invention.

FIG. 4 illustrates a process of finding the imaged display screen in a captured image frame by thresholding in accordance with some embodiments of the invention.

FIG. 5 illustrates a process of finding the imaged display screen in a captured image frame by searching for a frame of a display device in the image frame in accordance with other embodiments of the invention.

FIG. 6 illustrates a process of finding the imaged display screen in a captured image frame by searching for a quadrilateral region having a dominant color in the image frame in accordance with other embodiments of the invention.

FIG. 7 illustrates a process of finding the imaged display screen in a captured image frame by comparing the image frame with a reference image in accordance with other embodiments of the invention.

FIG. 8 is a process flow diagram of a method for tracking an input device in accordance with an embodiment of the invention.

FIG. 9 depicts a console unit, a display device, and a hand-held controller unit that work in conjunction with each other to enable a user to interface with graphical information on a display screen.

FIG. 10A depicts a display screen that displays some graphical information.

FIG. 10B depicts a graphical user interface that is overlaid on top of the graphical information depicted in FIG. 10A.

FIG. 10C illustrates the path of a visible indication as it moves from the previous position in FIG. 10B to the channel up graphical element.

FIG. 10D depicts an exemplary graphical user interface for controlling display device functionality that is not overlaid over other graphical information.

FIG. 10E depicts a graphical user interface similar to the graphical user interface of FIG. 10D in which the visible indication is a highlighted border that is generated by a visible indication module at a console unit.

FIG. 11 depicts an example of a technique for generating position data, which is indicative of the position of the hand-held controller unit relative to the display screen, using a pattern that is displayed on the display screen.

FIG. 12 is a process flow diagram of a method for interfacing with graphical information on a display screen in accordance with an embodiment of the invention.

Throughout the description similar reference numbers may be used to identify similar elements.

### DETAILED DESCRIPTION

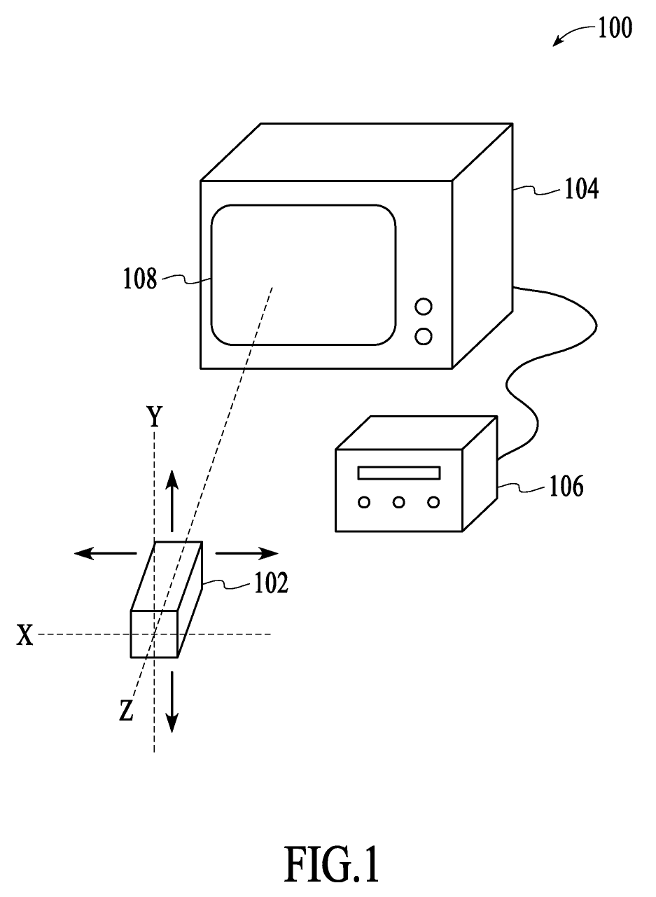

With reference to FIG. 1, an optical navigation system 100 in accordance with an embodiment of the invention is described. As shown in FIG. 1, the optical navigation system 100 includes a hand-held controller unit 102, a display device 104 having a display screen 108, and a console unit 106. In some embodiments, the hand-held controller unit 102 and the console unit 106 are part of a computer gaming system where the hand-held controller unit is an input device of the system to manipulate graphical elements displayed on the display device 104. However, in other embodiments, the optical navigation system 100 is used to implement other types of systems. For example, some embodiments of the optical navigation system 100 may be used to provide an accessible user interface for a computer system.

As described in more detail below, the optical navigation system 100 operates to track the movements of the hand-held controller unit 102 of the system using an image of the display screen 108 in frames of image data captured by the hand-held controller unit 102. Positional information of the imaged version of the display screen 108 in captured image frames is then used to determine the current position of the hand-held controller unit 102. The positional information of the display screen 108 in a captured image frame may include the location and size of the imaged display screen in the captured image frame with respect to the captured image frame, as well as the shape of the imaged display screen in the captured image frame. The current position of the hand-held controller unit 102 can be the position of the hand-held controller unit relative to an absolute coordinate system with respect to the display screen 108. Alternatively, the current position of the hand-held controller unit 102 can be the position of the hand-held controller unit relative to the previous position of the hand-held controller unit with respect to the display screen 108. This type of tracking using the imaged display screen in a captured image frame will sometimes be referred to herein as a screen-based navigation.

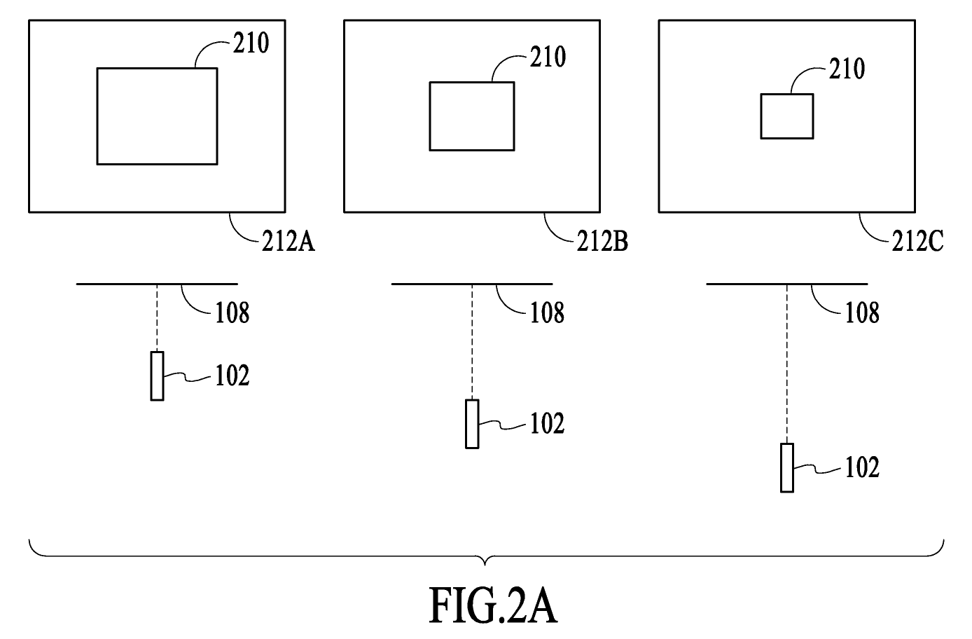

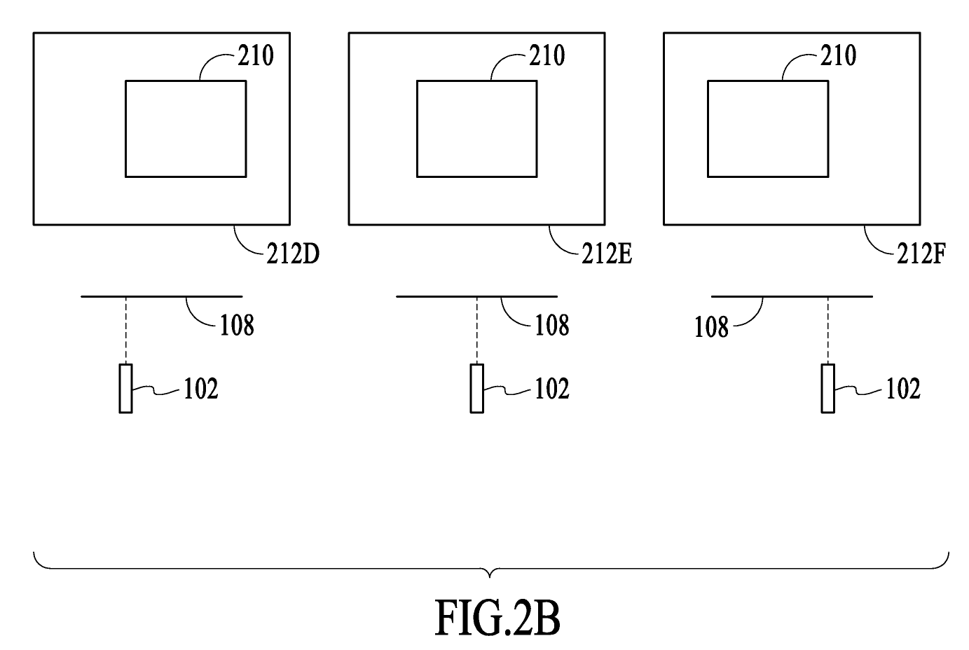

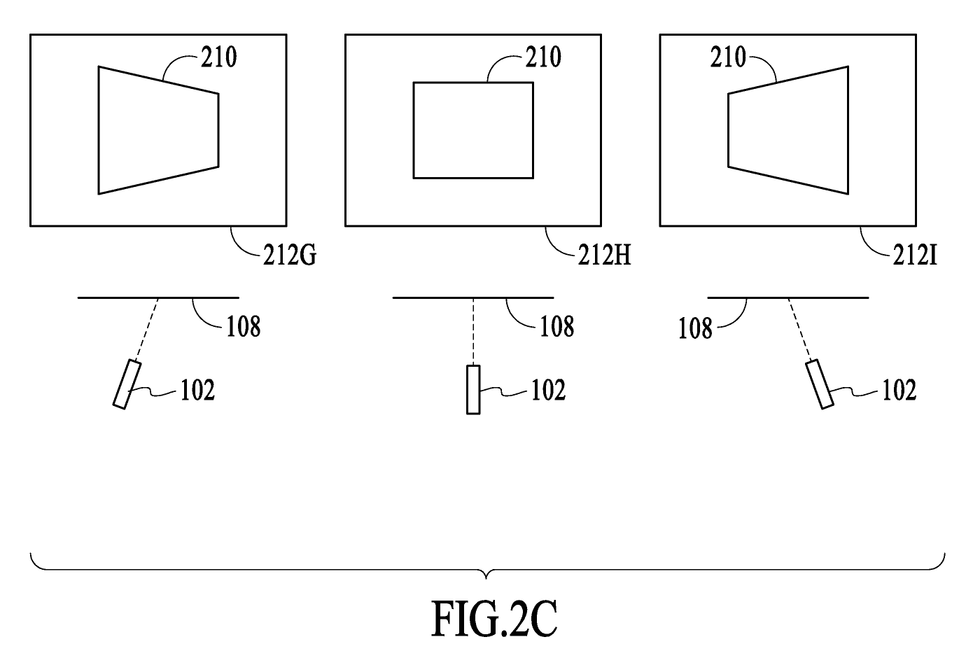

FIGS. 2A-2C illustrate how the positional information of an imaged display screen in a captured image frame can be used to determine the relative position of the hand-held controller unit 102 with respect to the display screen 108. FIG. 2A illustrates an imaged display screen 210 in captured image frames 212A, 212B and 212C when the hand-held controller unit 102 is moved closer or farther from the display screen 108. As shown in the captured image frame 212A, when the hand-held controller unit 102 is positioned near the display screen 108, the size of the imaged display screen 210 is relatively large. Furthermore, since the hand-held controller unit 102 is positioned directly in front of the display screen 108 and pointed to the display screen in a direction normal to the surface of the display screen, the shape of the imaged display screen 210 is rectangular in shape. However, as described below, the shape of the imaged display screen 210 can be any quadrilateral shape, such as a trapezoid or any other four-sided polygon (also known as quadrangle or tetragon), depending on the relative position of the hand-held controller unit 102 with respect to the display screen 108. As shown in the captured image frame 212B, when the hand-held controller unit 102 is moved away from the display screen 108, the size of the imaged display screen 210 is decreased. However, the shape of the imaged display screen 210 has not changed, which indicates that the angle of the hand-held controller unit 102 with respect to the display screen 108 has not changed. As shown in the captured image frame 212C, when the hand-held controller unit 102 is moved farther away from the display screen 108, the size of the imaged display screen 210 is further decreased. However, the shape of the imaged display screen 210 again has not changed, which indicates that the angle of the hand-held controller unit 102 with respect to the display screen 108 has not changed.

FIG. 2B illustrates the imaged display screen 210 in captured image frames 212D, 212E and 212F when the hand-held controller unit 102 is moved laterally at a fixed distance from the display screen 108. That is, the hand-held controller unit 102 is moved on a plane parallel to the surface of the display screen 108, where the plane is at a fixed distance from the display screen. As shown in the captured image frame 212E, when the hand-held controller unit 102 is positioned near the front of the display screen 108, the imaged display screen 210 is correspondingly located near the center of the captured image frame. Furthermore, since the hand-held controller unit 102 is positioned directly in front of the display screen 108 and pointed to the display screen in a direction normal to the surface of the display screen, the shape of the imaged display screen 210 is rectangular in shape. As shown in the captured image frame 212D, when the hand-held controller unit 102 is moved laterally to the left, the imaged display screen 210 has shifted to the right in the captured image frame. However, the size and shape of the imaged display screen 210 have not noticeably changed, which indicates that the hand-held controller unit 102 is positioned at or near the same distance away from the display screen 108 and the angle of the hand-held controller unit 102 with respect to the display screen 108 has not changed. As shown in the captured image frame 212F, when the hand-held controller unit 102 is moved laterally to the right, the imaged display screen 210 has shifted to the left in the captured image frame. However, the size and shape of the imaged display screen 210 again have not noticeably changed, which indicates that the hand-held controller unit 102 is positioned at or near the same distance away from the display screen 108 and the angle of the hand-held controller unit 102 with respect to the display screen 108 has not changed. The imaged display screen 210 will be similarly shifted up or down in a captured image frame if the hand-held controller unit 102 is laterally moved down or up at a fixed distance from the display screen 108.

FIG. 2C illustrates the imaged display screen 210 in captured image frames 212G, 212H and 212I when the hand-held controller unit 102 is moved such that the angle of the hand-held controller unit 102 with respect to the display screen 108 is changed. As shown in the captured image frame 212H, when the hand-held controller unit 102 is positioned or orientated such that the hand-held controller unit 102 is pointing to the center of the display screen in a direction normal to the surface of the display screen 108, the imaged display screen 210 is located near the center of the captured image frame and the shape of the imaged display screen is rectangular. As shown in the captured image frame 212G, when the hand-held controller unit 102 is moved to the left and the angle of the hand-held controller unit is changed with the hand-held controller unit still pointed to the center of the display screen 108, the shape of the imaged display screen 210 is changed to a particular type of a quadrangle, i.e., a trapezoid, such that the left side of the trapezoidal shape of the imaged display screen is longer than its right side. However, the size of the imaged display screen 210 has not noticeably changed, which indicates that the hand-held controller unit 102 is still positioned at or near the same distance away from the display screen 108. As shown in the captured image frame 212I, when the hand-held controller unit 102 is moved to the right and the angle of the hand-held controller unit has changed with the hand-held controller unit still pointed to the center of the display screen 108, the shape of the imaged display screen 210 is changed such that the right side of the trapezoidal shape of the imaged display screen 210 is now longer than its left side. However, the size of the imaged display screen 210 has not noticeably changed, which indicates that the hand-held controller unit 102 is still positioned at or near the same distance away from the display screen 108. The shape of the imaged display screen 210 will be similarly changed in a captured image frame if the hand-held controller unit 102 is moved up or down and the angle of the hand-held controller unit is changed with the hand-held controller unit still pointed to the center of the display screen 108.

Although not illustrated, the shape of the imaged display screen in captured image frames can also be used to determine if the hand-held controller unit 102 is rotated with respect to the display screen 108 on a plane parallel to the surface of the display screen. When the hand-held controller unit 102 is rotated clockwise, the imaged display screen in captured image frames will similarly be rotated in the counterclockwise direction in the captured image frames. When the hand-held controller unit 102 is rotated counterclockwise, the imaged display screen in captured image frames will similarly be rotated in the clockwise direction in the captured image frames.

Thus, using the size and shape of the imaged display screen in captured image frames, the relative position of the hand-held controller unit 102 can be determined by image analysis. The relative position of the hand-held controller unit 102 includes, but is not limited to, the distance from the display screen 108 to the hand-held controller unit 102, the lateral distance of the hand-held controller unit from the center of the display screen, the angle of the hand-held controller unit with respect to the display screen and the rotational orientation of the hand-held controller unit with respect to the display screen. In addition, using the relative position of the hand-held controller unit 102 with respect to the display screen 108, the location on the display screen to which the hand-held controller unit is pointed (referred to herein as “the screen intercept”), can be determined.

Turning back to FIG. 1, the hand-held controller unit 102 of the optical navigation system 100 is configured to electronically capture frames of image data, which contain at least a portion of the display screen 108. The hand-held controller unit 102 is also configured to process the captured image frames to find the imaged display screen in the captured image frames in order to extract positional information of the imaged display screen, such as location, size and shape of the imaged display screen in the captured image frames. The hand-held controller unit 102 is further configured to calculate the relative position of the hand-held controller unit using the positional information of the imaged display screen and to output position data that indicates the relative position of the hand-held controller unit. The relative position of the hand-held controller unit 102 can be the position of the hand-held controller unit relative to a predefined coordinate system of the optical navigation system 100. The coordinate system of the optical navigation system 100 may be established during a calibration stage. Alternatively, the relative position of the hand-held controller unit 102 can be the position of the hand-held controller unit relative to the previous position of the hand-held controller unit. The output position data may include x, y and z position values along the X, Y and Z axes of the coordinate system of the optical navigation system 100. Alternatively, the output position data may include Δx, Δy and Δz values along the X, Y and Z axes of the coordinate system of the optical navigation system 100, which represent changes or displacements along the respective axes. The output position data may also include a value of the angle of the hand-held controller unit 102 with respect to the display screen 108 and a value of the rotational angle of the hand-held controller unit with respect to the display screen. Alternatively, the output position data may include a change in angle value or a change in rotational angle value. In still another embodiment, the output position data could be x and y coordinates of the screen intercept.

The position data of the hand-held controller unit 102 is transmitted to the console unit 106, which is connected to the display device. In some embodiments, the console unit 106 is coupled to the display device 104 using conventional wiring. Alternatively, other wired or wireless connections may be implemented to provide connection between the console unit 106 and the display device 104. The console unit 106 processes the position data from the hand-held controller unit 102 for use in a particular application. As an example, the console unit 106 may be configured to manipulate a graphical element displayed on the screen 108 of the display device 104 according to the movements of the hand-held controller unit 102 as new position data is received from the hand-held controller unit. The console unit 106 may be a computer system, which runs one or more computer programs, such as gaming programs. In this embodiment, the console unit 106 may include components commonly found in a personal computer system.

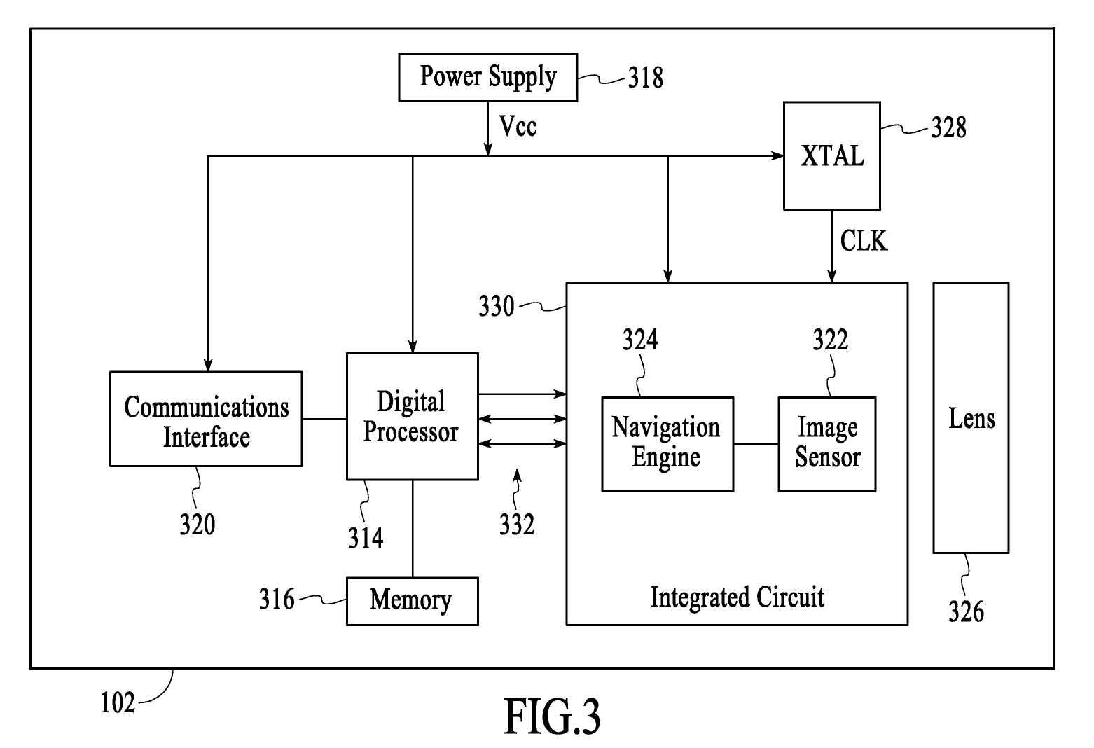

Turning now to FIG. 3, a block diagram of the hand-held controller unit 102 in accordance with an embodiment of the invention is shown. The illustrated hand-held controller unit includes a digital processor 314, a memory device 316, a power supply 318, a communications interface 320, an image sensor 322, a navigation engine 324, an optical lens 326 and a crystal oscillator 328. In the illustrated embodiment, the navigation engine 324 and the image sensor 322 are part of an integrated circuit (IC) 330. However, in other embodiments, the image sensor 322 and the navigation engine 324 may be implemented as separate components. The IC 330 is connected to the digital processor 314 via one or more signal lines 332, which may include address, data and/or control signal lines. Although the hand-held controller unit 102 is shown to include certain components, the hand-held controller unit may include additional components. For example, some embodiments of the hand-held controller unit 102 include input buttons, joysticks or other user interfaces typically used for hand-held controller units. Other embodiments of the hand-held controller unit 102 include feedback signal generators to generate a tactile or auditory feedback signal to a user.

In some embodiments, the digital processor 314 may be a general-purpose processor such as a microprocessor or microcontroller. In other embodiments, the digital processor 314 may be a special-purpose processor such as a digital signal processor. In other embodiments, the digital processor 314 may be another type of controller or a field programmable gate array (FPGA). In general, the digital processor 314 implements operations and functions of the hand-held controller unit 102.

The memory device 316 is configured to store data and/or instructions for use in the operation of the hand-held controller unit 102. In some embodiments, the memory device 316 stores instructions, which when executed by the digital processor 314, cause the digital processor to perform certain operations. Similarly, some instructions may be stored in memory integrated into the digital processor 314 or the IC 330. Additionally, the memory device 316 may store position data produced by the digital processor 314 and/or the navigation engine 324.

In an embodiment, the power supply 318 provides direct current (DC) electrical signal, Vcc, to the digital processor 314, as well as other components of the hand-held controller unit 102. Some embodiments of the power supply 318 include one or more batteries. In some embodiments, the power supply 318 receives power from the console unit 106 via a wire. In a similar manner, the crystal oscillator 328 provides a clock signal, CLK, to one or more of the components of the hand-held controller unit 102.

The communications interface 320, which is coupled to the digital processor 314, is configured to transmit signals such as position data signals from the hand-held controller unit 102 to the console unit 106. The communications interface 320 may also be configured to receive control signals, or feedback signals, from the console unit 106. Additionally, the communications interface 320 may facilitate wired or wireless communications. For example, the communications interface 320 may send electrical signals via a hard-wired connection to the console unit 106. Alternatively, the communications interface 320 may send wireless signals, such as radio frequency (RF) signals, using known wireless data transmission protocols.

The image sensor 322, which is also coupled to the digital processor 314, is configured to capture frames of image data. The image sensor 322 includes an electronic imaging sensor array, such as a complimentary metal-oxide-semiconductor (CMOS) image sensor array or a charge-coupled device (CCD) image sensor array. For example, the image sensor 322 may include a 320×240 pixel array to capture frames of image data. However, other embodiments of the image sensor 322 may include a smaller or larger pixel array to capture frames of image data with lower or higher resolution. In the depicted embodiment, the image sensor 322 is used in conjunction with the optical lens 326 to capture frames of image data. However, other embodiments may omit the lens 326, or implement multiple lenses.

In the illustrated embodiment, the navigation engine 324 is integrated with the image sensor 322 on the IC 330. In other embodiments, the navigation engine 324 may be partially or wholly integrated with the digital processor 314. Still in other embodiments, the navigation engine 324 may be partially or wholly incorporated into the console unit 106. In general, the navigation engine 324 processes frames of image data captured by the image sensor 322 to compute and output current position data with respect to the hand-held controller unit 102 using the imaged display screen in the captured image frames. During this process, the navigation engine 324 performs an operation that includes locating the imaged display screen in the captured image frames to extract positional information of the imaged display screen and then computing the relative position of the hand-held controller unit 102 using the positional information of the imaged display screen to produce position data for the computed relative position of the hand-held controller unit.

In some embodiments, as illustrated in FIG. 4, the navigation engine 324 finds the imaged display screen 410 in a captured image frame 412A by comparing each pixel value of the captured image frame, e.g., the luminance value for each pixel, to a threshold value. The resulting image frame 412B will have a bright or dark quadrilateral region 413 defined by a quadrilateral outline 414 due to the thresholding, which represents the imaged display screen 410. As an example, the quadrilateral outline 414 may be a trapezoidal outline, depending on the relative position of the hand-held controller unit 102 with respect to the display screen 108.

The underlying basis for this approach is that the area within the imaged display screen in a captured image frame will most likely be brighter than the area outside of the imaged display screen. Thus, by thresholding the pixel values of the captured image frame, the area within the imaged display screen can be identified. As a result, the imaged display screen is located in the captured image. The outline of the identified quadrilateral region in the captured image frame is then used to extract positional information of the imaged display screen. In an embodiment, the extracted positional information of the imaged display screen includes locations of the corners of the identified quadrilateral outline, which may be represented by coordinates of a rectangular coordinate system based on the captured image frame where the center of the coordinate system is a predefined point in the captured image frame, e.g., the top left corner of the captured image frame. The corners of the identified quadrilateral outline may be found using the intersections of the sides or edges of the identified quadrilateral region.

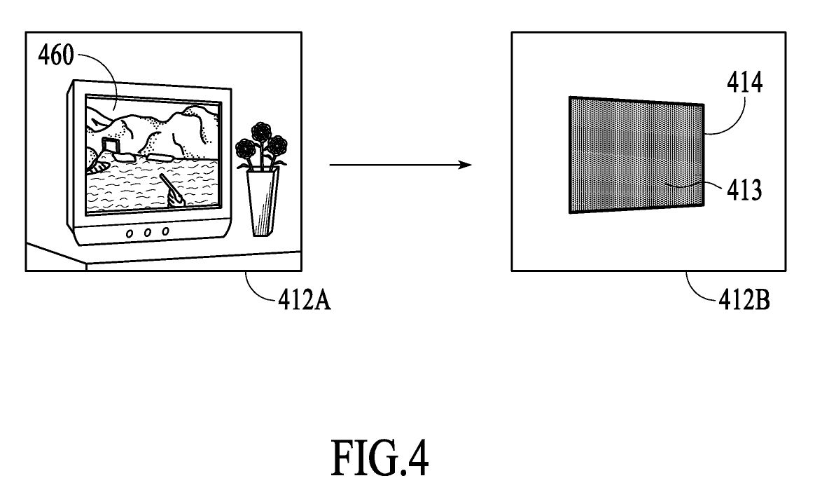

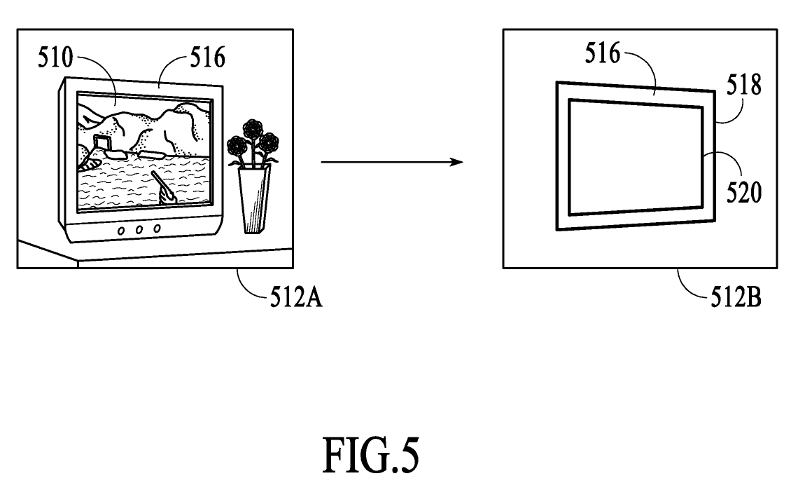

In other embodiments, as illustrated in FIG. 5, the navigation engine 324 finds the imaged display screen 510 in a captured image frame 5 12A by looking for a quadrilateral frame 516 having a uniform color. The quadrilateral frame 516 includes an outer quadrilateral outline 518 and an inner quadrilateral outline 520, as shown in the resulting image frame 512B. The inner quadrilateral outline 520 represents the outline of the imaged display screen 410 in the captured image frame 512A.

The underlying basis for this approach is that display devices typically have a rectangular frame surrounding the display screen. Thus, the inner outline of the rectangular frame is equivalent to the outline of the display screen. The rectangular frame is usually black, brown or some other uniform color. Thus, if the rectangular or other quadrilateral frame can be found in a captured image frame, the inner outline of the rectangular or quadrilateral frame can be used to identify the imaged display screen in the captured image frame. The inner outline of the quadrilateral frame in the captured image frame is then used to extract positional information of the imaged display screen. In an embodiment, the extracted positional information of the imaged display screen includes locations of the corners of the inner outline of the quadrilateral frame, which may be represented by coordinates of a rectangular coordinate system based on the captured image frame. The corners of the inner outline of the quadrilateral frame may be found using the intersections of the sides of the inner outline of the quadrilateral frame.

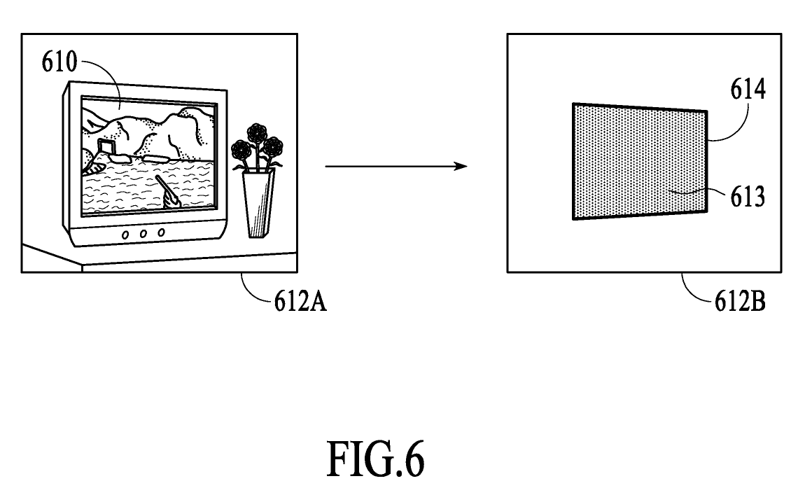

In other embodiments, as illustrated in FIG. 6, the navigation engine 324 finds the imaged display screen 610 in a captured image frame 612A by searching for a quadrilateral region 613 having a dominant color, for example, a quadrilateral region that is mainly blue. The outline 614 of the quadrilateral region 613 having a dominant color in the resulting image frame 612B represents the imaged display screen 610 in the captured image frame 612A.

The underlying basis for this approach is that the imaged display screen in a captured image frame will sometimes include an image having a dominant color. Thus, by looking for a quadrilateral region having a dominant color, the area within the imaged display screen can be identified. As a result, the imaged display screen is located in the captured image. The identified quadrilateral outline in the captured image frame is then used to extract positional information of the imaged display screen. In an embodiment, the extracted positional information of the imaged display screen includes locations of the corners of the identified quadrilateral outline, which may be represented by coordinates of a rectangular coordinate system based on the captured image frame. The corners of the identified quadrilateral outline may be found using the intersections of the sides of the identified quadrilateral outline.

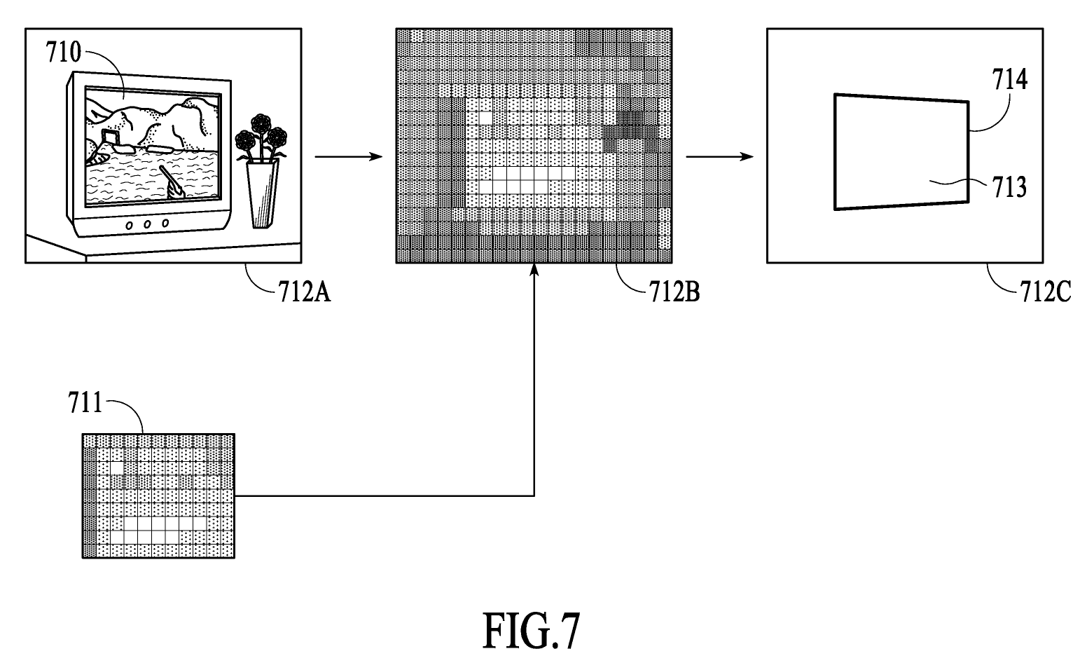

In other embodiments, as illustrated in FIG. 7, the navigation engine 324 finds the imaged display screen 710 in a captured image frame 712A by searching for a quadrilateral region in the captured image frame similar to a reference image 711. The reference image 711 is the image currently being displayed on the display screen 108 of the display device 104. The reference image 711 may be a lower resolution version of the image being displayed on the display screen 108. In this implementation, the resolution of the captured image frame can be converted the same lower resolution of the reference image 711, as illustrated in the image frame 712B. In some embodiments, the reference image 711 is transmitted from the console unit 106 to the hand-held controller unit 102 to be used by the navigation engine 324. In other embodiments, the captured image frame 712A is transmitted to the console unit 106 to be used by the navigation engine 324 at the console unit, assuming that the connection between the console unit and the hand-held controller unit 102 has sufficient bandwidth. The captured image frame 712B is then compared with the reference image 711 to find a quadrilateral region 713 in the image frame that represents the imaged display screen 710. The outline 714 of the quadrilateral region 713 in the resulting image frame 712C represents the outline of the imaged display screen 710 in the captured image frame 712A.

The underlying basis for this approach is that the image on the display screen 108 can be used to find the imaged display screen in a captured image frame as a quadrilateral region. The outline of the identified quadrilateral region in the resulting image frame is then used to extract positional information of the imaged display screen. In an embodiment, the extracted positional information of the imaged display screen includes locations of the corners of the identified quadrilateral outline, which may be represented by coordinates of a rectangular coordinate system based on the captured image frame. The corners of the identified quadrilateral outline may be found using the intersections of the sides of the identified quadrilateral outline.

In some embodiments, the navigation engine 324 may use a common aspect ratio for a display screen to locate and/or to verify the quadrilateral area or outline that has been identified as the imaged display screen or the outline of the imaged display screen. As an example, the navigation engine 324 may determine whether the quadrilateral area or outline found in a captured frame of image data has an aspect ratio of 4:3 or 16:9, which is common for television and computer screens.

In some embodiments, the navigation engine 324 may use more than one of the above-described processes to find the imaged display screen in a frame of image data. As an example, the navigation engine 324 may dynamically switch from one process to another depending on the image currently being displayed on the display screen 108. As another example, the navigation engine 324 may switch from one process to another, depending on the effectiveness of the former process to find the imaged display screen in the captured image frames.

In some embodiments, the navigation engine 324 may extrapolate missing information of the imaged display screen in a captured image frame using the available information. As an example, a captured image frame may include only a portion of the imaged display screen such that a corner of the imaged display screen is missing from the captured image frame. In such a situation, the navigation engine 324 can use the locations of the three other corners and/or the sides of the identified display screen in the captured image frame to extrapolate the location of the missing corner of the imaged display screen. Thus, an estimated location of the missing corner of the imaged display screen can be calculated.

After the imaged display screen in a captured image frame is found and positional information of the imaged display screen has been extracted, the navigation engine 324 uses the positional information of the imaged display screen to calculate the position of the hand-held controller unit 102 with respect to the display screen 108. In some embodiments, only the outline of the imaged display screen and/or the locations of the corners of the imaged display screen in the captured image frame are used to calculate the relative position of the hand-held controller unit 102. The position of the hand-held controller unit 102 relative to the display screen 108 can be derived from the positional information of the imaged display screen by applying conventional mathematical calculations and using the concepts described herein. Alternatively, a look-up table can be used to determine the relative position of the hand-held controller unit 102 using the coordinates of the four corners of the imaged display screen. As previously stated, the relative position of the hand-held controller unit 102 includes, but is not limited to, the distance from the display screen 108 to the hand-held controller unit 102, the lateral distance of the hand-held controller unit from the center of the display screen, the angle of the hand-held controller unit with respect to the display screen and the rotational orientation of the hand-held controller unit with respect to the display screen. As a result, the navigation engine 324 generates position data that includes information regarding the current relative position of the hand-held controller unit 102.

In some embodiments, the navigation engine 324 may also perform scene-based navigation using a lower resolution version of the captured image frames. The scene-based navigation is performed using conventional image correlation, which is typically used in computer mice applications. As an example, the image sensor 322 of the hand-held controller unit 102 can be sub-windowed to a 32×32 pixel array to capture lower resolution image frames, which can then be image correlated to track the movements of the hand-held controller unit 102. In these embodiments, the scene-based navigation can be performed for most of the tracking of the hand-held controller unit 102, while the screen-based navigation can be used sparingly for re-calibration. Using the scene-based navigation mode for most of the tracking of the hand-held controller unit 102 would result in significant power saving since scene-based navigation is less computationally intensive than the screen-based navigation mode.

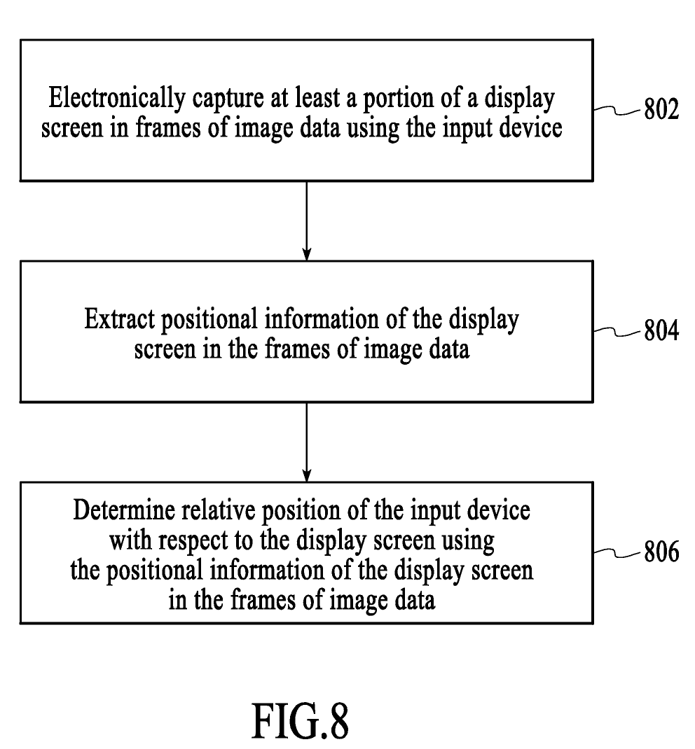

A method for tracking an input device in accordance with an embodiment of the invention is described with reference to a process flow diagram of FIG. 8. At block 802, at least a portion of a display screen in frames of image data is electronically captured using the input device. Next, at block 804, positional information of the display screen in the frames of image data is extracted. Next, at block 806, relative position of the input device with respect to the display screen is determined using the positional information of the display screen in the frames of image data.

Once the position data, which is indicative of the position of the hand-held controller unit 102 relative to the display screen 108, is generated, the position data can be used to interface with graphical information that is displayed on the display screen. For example, the position data can be used to navigate through a graphical user interface that is displayed on the display screen.

In accordance with an embodiment of the invention, a technique for interfacing with graphical information on a display screen involves using a hand-held controller unit to collect image information that includes at least a portion of the display screen and using the image of the display screen to generate position data that is indicative of the position of the hand-held controller unit relative to the display screen. An action in a computer program related to the graphical information is then triggered in response to the position data and in response to a user input at the hand-held controller unit. The ability to interface with the graphical information on the display screen is enhanced if the user of the hand-held controller unit is provided with a visible indication of the position of the hand-held controller unit relative to the display screen, e.g., an indication of where the hand-held controller unit is pointed. In an embodiment, the hand-held controller unit generates a light beam that indicates the direction in which the controller unit is pointed. The light beam is visible as a spot on the display screen and provides instantaneous feedback to the user as to the position of the hand-held controller unit relative to the display screen. In another embodiment, a visible indication of the position of the hand-held controller unit relative to the display screen is electronically generated from the position data and displayed as a graphical element on the display screen.

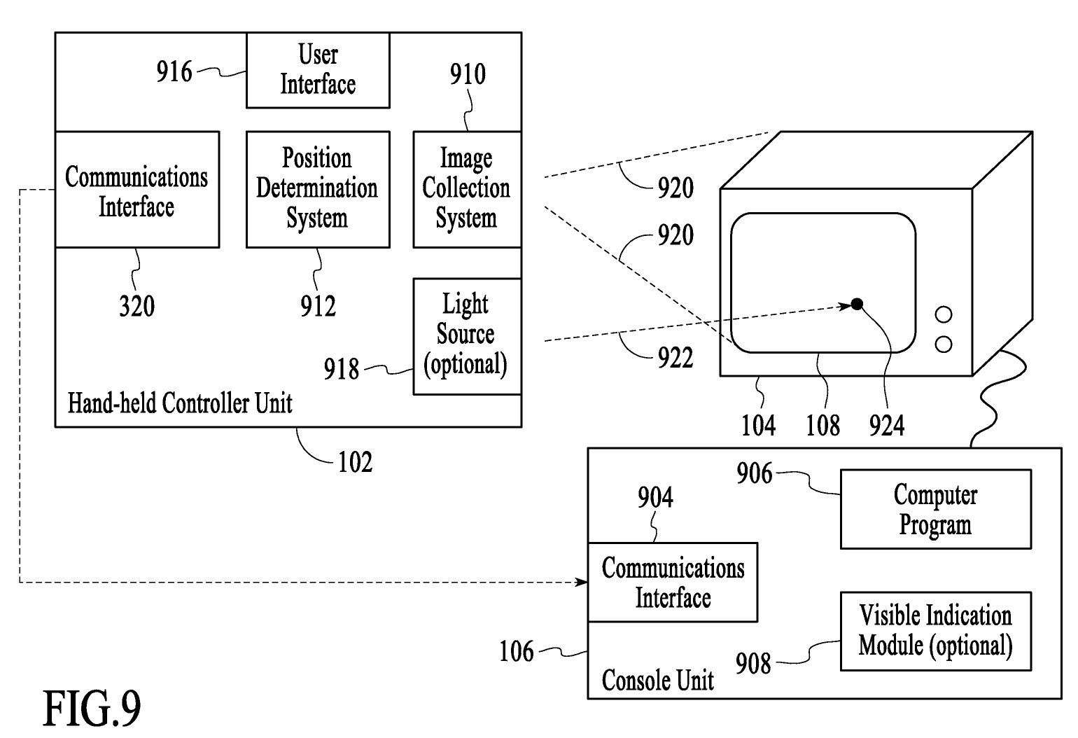

FIG. 9 depicts a console unit 106, a display device 104, and a hand-held controller unit 102 that work in conjunction with each other to enable a user to interface with graphical information on a display screen 108. In the embodiment of FIG. 9, the console unit is similar to the console unit described above with reference to FIG. 3. Alternatively, the console unit may be any computing device that is capable of supporting a graphical user interface. The console unit may be integrated into a television set, the console unit may be a stand alone computer system such as a desktop or laptop computer, or the console unit may be some other computer system. The console unit includes memory and a processor (not shown) that are capable of running a computer program, a communications interface 904 that is capable of communicating with the hand-held controller unit, and a computer program 906 that generates a graphical user interface on the display screen. In an embodiment, the console unit may include a visible indication module 908 that is configured to generate a visible indication of the position of the hand-held controller unit relative to the display screen in response to the position data from the hand-held controller unit.

The display device 104 is capable of displaying graphical information, including a graphical user interface. The display device has a display screen 108 and the display device can be any type of display device, including but not limited to a television or a computer monitor. The display screen is the area on which graphical information is displayed.

The hand-held controller unit 102 includes an image collection system 910, a position determination system 912, a communications interface 320, a user interface 916, and may include a light source 918. The depiction of the hand-held controller unit provided in FIG. 9 illustrates an embodiment of functional elements that enable a user to interact with graphical information on the display screen. The functional elements depicted in FIG. 9 may include combinations of the elements described with reference to FIG. 3.

Referring to FIG. 9, the image collection system 910 collects image information, typically as a frame or frames of image information. In an embodiment, the image collection system includes the image sensor 322 and the lens 326 as described above with reference to FIG. 3. Although the image collection system includes the image sensor and the lens as described above, the image collection system may alternatively include other image collection elements, including other types of image sensors and/or other optical elements. The image information collected by the image collection system is used to generate position data. In order for the hand-held controller unit to interact with graphical information on the display screen, the image collection system includes a field of view 920 that enables at least a portion of the display screen 108 to be included in the image information when the hand-held controller unit 102 is pointed at the display screen.

The position determination system 912 generates position data, which is indicative of the position of the hand-held controller unit relative to the display screen, using the image information generated from the image collection system 910. In an embodiment, the position determination system includes the navigation engine 324 and the digital processor 314 as described above with reference to FIG. 3. Although the position determination system may include the navigation engine and the digital processor as described above, the position determination system may include other processing elements instead of or in addition to the above described elements.

The communications interface 320 enables the hand-held controller unit 102 to communicate position data to the console unit. The communications interface is described in more detail above with reference to FIG. 3.

The user interface 916 enables a user to initiate a command via the hand-held controller unit 102. In an embodiment, the user interface is a button that is activated with a finger although the user interface can be any type of user interface that enables a user to trigger a command via the hand-held controller unit.

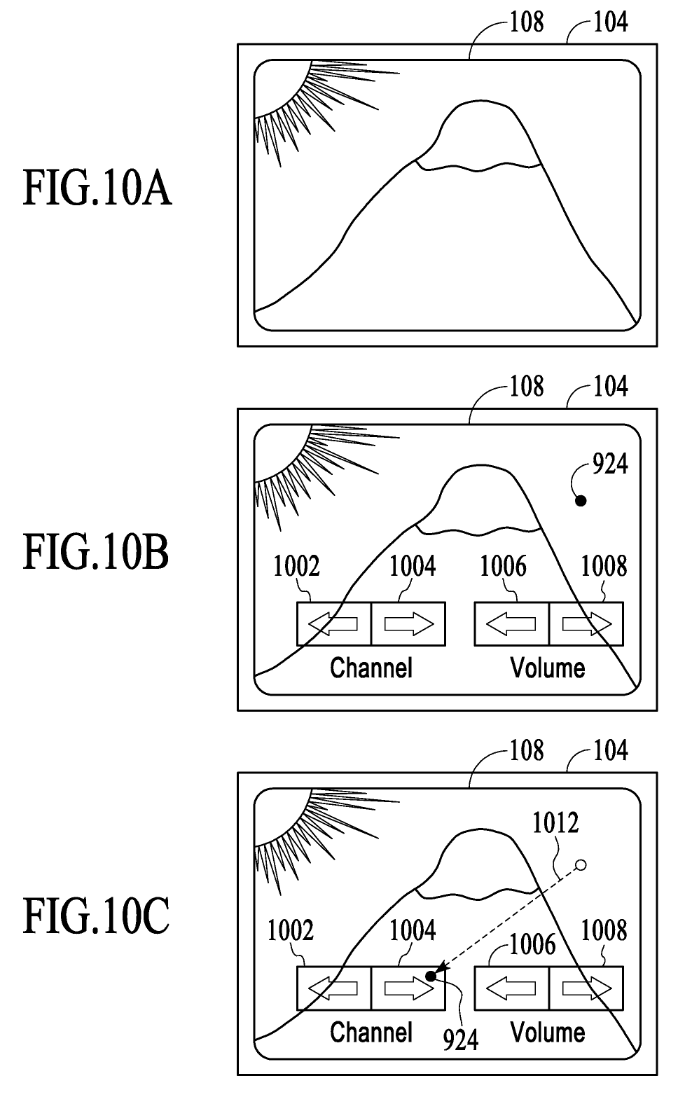

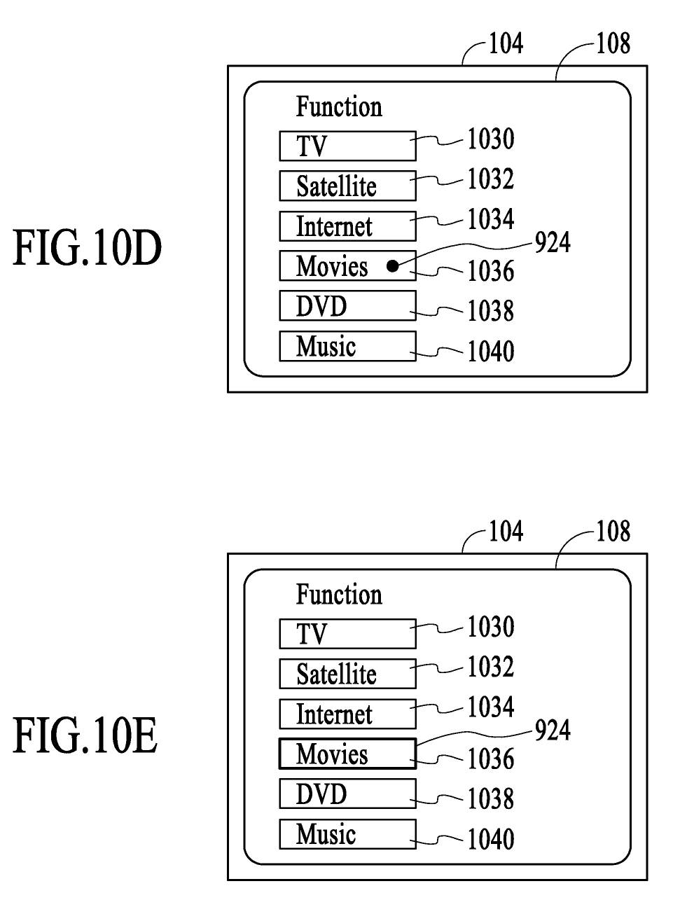

The light source 918 is a laser or a light emitting diode (LED) that generates a beam of light 922. When the beam of light is pointed at the display screen 108, the beam of light provides a visible indication 924 of the position of the hand-held controller unit relative to the display screen (referred to herein as a “light spot”). In particular, the light spot indicates the direction in which the hand-held controller unit is pointing. In an embodiment, the light source is oriented within the hand-held controller unit to output the beam of light within the field of view of the image collection system. For example, the light source is oriented such that the beam of light is projected at the center of the image collection system's field of view. In an embodiment, the position determination system is configured to generate position data that corresponds to the position of the light spot on the display screen. As is described in more detail below, generating position data that corresponds to the position of the light spot on the display screen enables a user to successfully navigate and interface with a graphical user interface that is displayed on the display screen. An exemplary operation of the system of FIG. 9 is described below with reference to FIGS. 10A-10E.

FIG. 10A depicts a display screen 108 that displays some graphical information. The graphical information may include full motion video, still images, or any combination thereof. In an embodiment, the graphical information is provided to the display device by the console unit 106 although some portion of the graphical information may be provided from some other source. For example, at least a portion of the graphical information may be provided to the display device from a satellite receiver, a cable set-top box, an Internet connection, or a DVD player.

FIG. 10B depicts a graphical user interface that is overlaid on top of the graphical information depicted in FIG. 10A. The graphical user interface includes channel control and volume control graphical elements 1002, 1004, 1006, 1008, which relate to channel control and volume control functionality, although it should be understood that other types of graphical elements and functionality can be integrated into the graphical user interface. In an embodiment, display of the graphical user interface is initiated by the user, for example, via a command entered at the hand-held controller unit 102. Once the graphical user interface is initiated, the hand-held controller unit is pointed at the display screen 108 such that the visible indication 924 is located on the display screen. With the visible indication located somewhere on the display screen, the user can move the hand-held controller unit while obtaining instantaneous visual feedback as to the location of the hand-held controller unit relative to the display screen. For example, to navigate to the channel up graphical element, the user moves the hand-held controller unit until the visible indication is within the borders of the channel up graphical element 1004. FIG. 10C illustrates the path 1012 of the visible indication (e.g., the light spot) as it moves from the previous position in FIG. 10B to the channel up graphical element. Once the visual indication is in the desired location within the display screen, the user triggers a command via the user interface on the hand-held controller unit. For example, the user presses a button on the hand-held controller unit to trigger a channel up command or releases a light activation button, e.g., a button that is held down to turn on the light and released to turn off the light, to trigger a channel up command. In response to the user input, the image collection system collects image information that includes an image of at least a portion of the display device and the position determination system 912 generates position data, which is indicative of the position of the hand-held controller unit relative to the display screen, using the image of the display screen that is included within the image information. The position data can be generated, for example, by finding the quadrilateral region of the display screen as described above. Although some techniques for generating position data using the image of the display screen is described above, other techniques for using the image of the display screen to generate position data are possible. Additionally, in other embodiments, the position data can be generated from the image information when the image information includes an image of only a portion of the display screen, for example, only one corner of the display screen.

Once the position data is generated, the position data is provided to the console unit 106. For example, the position data is communicated from the hand-held controller unit 102 to the console unit via the communications interfaces 320 and 904 of the respective devices. The console unit compares the position data, which corresponds to the position of the hand-held controller unit relative to the display screen 108 at the moment the user input was made, to knowledge of the graphical user interface to determine the action that should be triggered in the computer program 906. In this embodiment, the process of collecting image information and generating new position data is not started again unless or until another user input is made. In the example of FIG. 10C, the position of the hand-held controller unit relative to the display screen at the moment the user input was made corresponds to a “channel up” command in the graphical user interface and as a result of the position of the hand-held controller unit at the time of the user input, the computer program triggers a channel up operation. Channel down, volume up, and volume down operations can be initiated by moving the hand-held controller unit such that the visible indication is positioned within the corresponding functional element and initiating a user input.

It should be noted that the visible indication 924 is simply a visible indication of the position of the hand-held controller unit relative to the display screen 108. The position data, which is used to trigger the corresponding functionality, is obtained from the collected image information that includes an image of at least a portion of the display screen and not from the visible indication. The visible indication simply provides the user of the hand-held controller unit with easily recognizable feedback as to the position of the hand-held controller unit relative to the display screen.

Further, in the embodiment of FIGS. 10-10C, the position of the hand-held controller unit relative to the display screen is only periodically determined. For example, as the user moves the visible indication within the display screen, image information is only captured and position information is only determined in response to a specific user input, such as the user pressing or releasing a button. Once the user input is made, the image information is captured and position information is generated for the specific position of the hand-held controller unit at the time of the user input. After the user input is made, the user can continue moving the hand-held controller unit to navigate the graphical user interface without triggering the capture of image information and the generation of position information until a next user input is made. This type of “point and shoot” functionality limits the image capture and position determination operations to discrete operations that are directly associated with a discrete user input. In contrast to the above-described technique, optical mouse navigation involves continuously capturing image information and generating position information as the mouse is moved along a navigation surface.

In the example of FIGS. 10A-10C, the graphical user interface is overlaid on top of other graphical information such as video content. In an alternative embodiment, the graphical user interface is not overlaid on top of any other graphical information. That is, the graphical user interface is the only graphical information displayed on the display screen. FIG. 10D depicts an exemplary graphical user interface for controlling display device functionality that is not overlaid over other graphical information. The graphical user interface includes graphical elements 1030, 1032, 1034, 1036, 1038, and 1040 that relate to the type or source of content that is displayed on the display screen. For example, graphical elements in the graphical user interface may indicate the type or source of content as one of television, satellite, Internet, movies, DVD, and music. In operation, once the graphical user interface is displayed on the display screen 108, the user moves the hand-held controller unit to navigate within the graphical user interface. As described above, the visible indication 924 tracks the movement of the hand-held controller unit relative to the display screen to provide the user with instantaneous feedback as to the position of the hand-held controller unit. Once the user is satisfied that the position of the hand-held controller unit corresponds to a desired position within the graphical user interface, an action can be triggered by a user input made via the user interface. For example, a user can trigger movie functionality by positioning the visible indication within the “movies” graphical element and then providing a user input via the user interface. In response to the user input, position data, which is indicative of the position of the hand-held controller unit relative to the display screen, is generated and provided to the console unit 106. The computer program 906 within the console unit translates the position data into a corresponding command. For example, the computer program recognizes that the position data provided by the hand-held controller unit corresponds to the “movies” graphical element and triggers functionality associated with movies. In an embodiment, selection of the movies graphical element triggers a different graphical user interface that includes, for example, a menu of movies that can be navigated through and selected.

The visible indication 924 of the position of the hand-held controller unit relative to the display screen does not have to be generated by a beam of light from the hand-held controller unit 102 nor does the visible indication have to be a spot on the display screen. FIG. 10E depicts a graphical user interface similar to the graphical user interface of FIG. 10D in which the visible indication is a highlighted border that is generated by the visible indication module at the console unit. In this example, the hand-held controller unit generates position data that is communicated to the console unit. The visible indication module of the hand-held controller unit translates the position data into a visible indication of the position of the hand-held controller unit relative to the display screen. For example, if the hand-held controller unit is positioned such that it points to a graphical element within the graphical user interface, then the visible indication module causes the border of the corresponding graphical element to be highlighted. Highlighting the graphical element provides a visible indication of the position of the hand-held controller unit relative to the display screen. For example, in FIG. 10E, the hand-held controller unit is positioned such that it points towards the “movies” graphical element and therefore the border of the movies graphical element is highlighted. As the user moves the hand-held controller unit, borders of the graphical elements within the graphical user interface will be highlighted to correspond to changes in the position of the hand-held controller unit.

In an embodiment where the position data is generated by comparing successive frames of image information, the hand-held controller unit may not update the console unit with new position information at the same rate new frames are captured and/or new position information is generated. In one embodiment, the hand-held controller unit communicates new position information to the console unit only after a threshold has been exceeded, e.g., a movement threshold that indicates a minimum required movement before new position information is communicated. Accordingly, the frame capture rate at the image collection system of the hand-held controller unit can be independent of the rate at which the console unit is updated with new position information. Limiting the transmission of new position information from the hand-held controller unit to the console unit can help to conserve power at the hand-held controller unit.

Although a few examples of graphical user interfaces, graphical elements, and visible indications are described, other graphical user interfaces, graphical elements, and visible indications are possible. For example, in an embodiment, the graphical information is a scene, for example, a scene in a video game such as a first person shooter game. The visible indication provides an indication of the position of the hand-held controller unit 102 relative to the scene and allows the user to interact with the scene. For example, the user can move the visible indication within the scene as if the visible indication were the target of a shooting device. When the visible indication is at the desired location within the scene, the user can make a user input to the user interface of the hand-held controller unit in order to trigger the shooting device. Once the user input is made, position data is generated and communicated to the console unit 106. The console unit uses the position data in executing a shooting operation. New position information is not generated until the user makes another user input.

Although a few examples of techniques for generating position data from the image of the display screen 108 are described above, other techniques for generating position data from the image of the display screen are possible. For example, techniques that can generate position data with less than four corners of the display screen captured in the image information are possible.

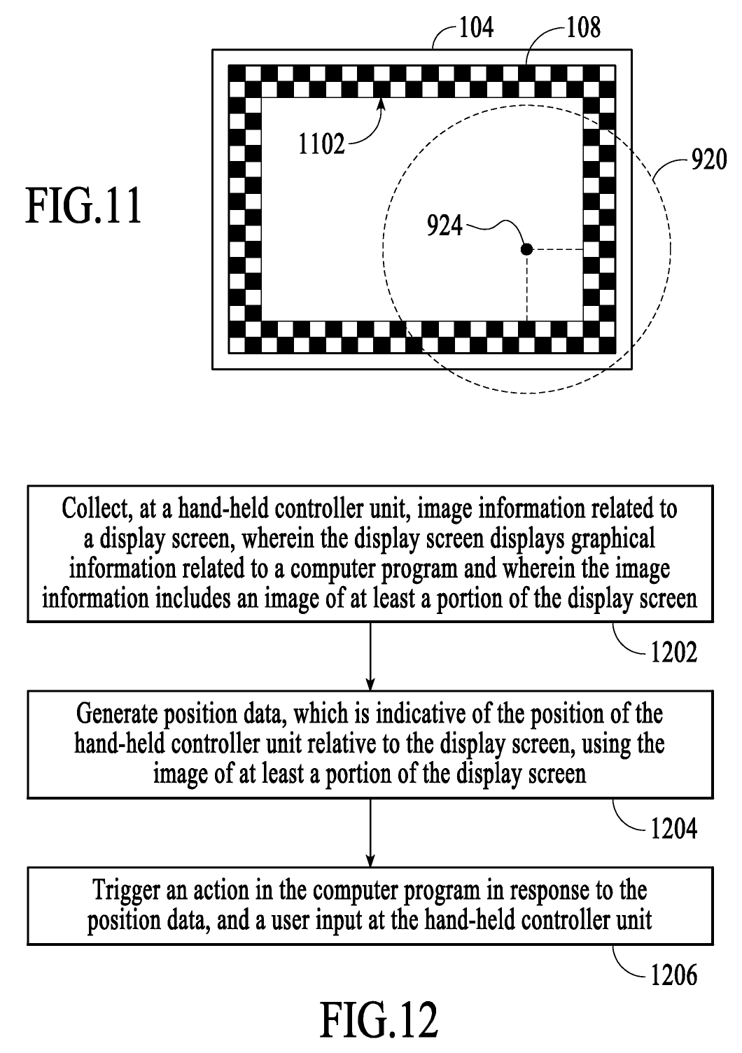

An example of a technique for generating position data, which is indicative of the position of the hand-held controller unit 102 relative to the display screen 108, using the image of at least a portion of the display screen is described with reference to FIG. 11. According to this technique, a computer program in the console unit 106 generates a border 1102 within the display screen. When image information is captured, the captured image information includes an image of the border and the image of the displayed border is used to generate the position data. In the embodiment of FIG. 11, the border includes a checkerboard pattern of squares with known dimensions that are used to generate the position data. For example, the position of the hand-held controller unit relative to the display device is determined by counting the number of squares between the center of the image and two borders, for example, the bottom-side and the right-side borders. Although a checkerboard pattern is described, other patterns that enable the position of the hand-held controller unit to be determined can be used.

In an embodiment, the border 1102 is only flashed on the display screen 108 in response to a user input. Further, the border can be flashed on the display screen for a short enough period that the border is invisible to the human eye. Although a checkerboard pattern is described with reference to FIG. 11, other patterns may be displayed on the display screen to enable the position of the hand-held controller unit relative to the display screen to be generated. Further, the pattern can be displayed in a configuration other than a border.

In an embodiment, the beam of light 922 is generated only when the user interface 916 is engaged and position data is generated and provided to the console unit 106 only upon the user interface being disengaged. That is, a user of the hand-held controller unit 102 presses a button on the hand-held controller unit to turn on the beam of light and navigates the graphical user interface with the button pressed. Once the hand-held controller unit is pointed at the desired graphical element, the button is released, thereby triggering the collection of image information and the generation of position data. The position data is then provided to the console unit, thereby triggering the desired action in the computer program.

In an embodiment, the position data communicated to the console unit 106 represents the position of the hand-held controller unit slightly before the user input is made. This is done because a user may tend to shake the hand-held controller unit slightly in the act of making the user input.

An advantage of a computer generated visible indication (e.g., a visible indication generated by the console unit) is that a light beam such as a laser beam is not needed. Avoiding the use of a laser eliminates laser safety concerns and eliminates the power requirement to drive the laser. On the other hand, a computer generated visible indication requires a higher volume of position data to be communicated to the console unit. This drives up the power requirement at the hand-held controller unit and increases the load on the communications interfaces of the hand-held controller unit and the console unit.

FIG. 12 is a process flow diagram of a method for interfacing with graphical information on a display screen in accordance with an embodiment of the invention. At block 1202, image information related to a display screen is collected at a hand-held controller unit, wherein the display screen displays graphical information related to a computer program and wherein the image information includes an image of at least a portion of the display screen. At block 1204, position data, which is indicative of the position of the hand-held controller unit relative to the display screen, is generated using the image of at least a portion of the display screen. At block 1206, an action is triggered in the computer program in response to the position data and a user input at the hand-held controller unit.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for interfacing with graphical information on a display screen, the method comprising:
collecting, at a hand-held controller unit, image information related to a display screen, wherein the display screen displays graphical information related to a computer program and wherein the image information includes an image of at least a portion of the display screen;
generating position data, which is indicative of the position of the hand-held controller unit relative to the display screen, using the image of at least a portion of the display screen; and
triggering an action in the computer program in response to the position data and a user input at the hand-held controller unit.

2. The method of claim 1 further comprising providing a visible indication of the position of the hand-held controller unit relative to the display screen.

3. The method of claim 2 wherein the visible indication corresponds to the position of the hand-held controller unit relative to the display screen.

4. The method of claim 1 further comprising generating a beam of light at the hand-held controller unit that provides a visible indication of the position of the hand-held controller unit relative to the display screen.

5. The method of claim 1 wherein the image information is collected and the position data is generated in response to the user input that is intended to trigger the action in the computer program.

6. The method of claim 1 wherein generating position data comprises identifying at least one corner of the display screen from the image information.

7. A hand-held controller unit for interfacing with graphical information on a display screen, the hand-held controller unit comprising:
an image collection system configured to collect image information related to a display screen that displays graphical information, wherein the image information includes an image of at least a portion of the display screen;
a position determination system configured to generate position data, which is indicative of the position of the hand-held controller unit relative to the display screen, using the image of at least a portion of the display screen;
a communications interface configured to communicate the position data to a computer program that controls the display of the graphical information on the display screen; and
a user interface configured to enable a user of the hand-held controller unit to trigger an action in the computer program;
wherein an action is triggered in the computer program in response to the position data of the hand-held controller unit relative to the display screen and a user input made via the user interface.

8. The hand-held controller unit of claim 7 further comprising a light source for providing a visible indication of the position of the hand-held controller unit relative to the display screen.

9. The hand-held controller unit of claim 8 wherein the image collection system has a field of view and wherein the light source is oriented within the hand-held controller unit to output a beam of light within the field of view of the image collection system.

10. The hand-held controller unit of claim 9 wherein the position determination system is configured to identify at least one corner of the display screen from the image information to generate the position data.

11. The hand-held controller unit of claim 7 wherein the position determination system is configured to identify at least one corner of the display screen from the image information to generate the position data.

12. A method for interfacing with graphical information on a display screen, the method comprising:
displaying graphical information related to a computer program on a display screen;
collecting, at a hand-held controller unit, image information that includes an image of at least a portion of the display screen;
generating position data, which is indicative of the position of the hand-held controller unit relative to the display screen, using the image of at least a portion of the display screen that is included within the image information;
providing a visible indication of the position of the hand-held controller unit relative to the display screen; and
triggering an action in the computer program via the hand-held controller unit in response to the position data and the visible indication of the position of the hand-held controller unit relative to the display screen.

13. The method of claim 12 wherein triggering an action in the computer program comprises generating position data when the visual indication of the position of the hand-held controller unit relative to the display screen corresponds to a desired position within the graphical information that is displayed on the display screen.

14. The method of claim 13 wherein the action is triggered via user input to a user interface on the hand-held controller unit.

15. The method of claim 14 wherein generating position data comprises identifying at least one corner of the display screen from the image information.

16. The method of claim 12 wherein generating position data comprises identifying four corners of the display screen from the image information.

17. The method of claim 12 wherein providing a visible indication of the position of the hand-held controller unit relative to the display screen comprises outputting a light beam from the hand-held controller unit.

18. The method of claim 17 wherein the orientation of the light beam corresponds to the location of the collected image information.

19. The method of claim 12 wherein providing a visible indication of the position of the hand-held controller unit relative to the display screen comprises providing a computer generated visible indication on the display screen using the position data.

20. The method of claim 12 wherein generating the position data comprises displaying a pattern on the display screen and using an image of the pattern to determine the position of the hand-held controller unit relative to the display screen.
